(19) United States
(12) Patent Application Publication
(10) Pub. No.: US 2015/0302119 A1
(43) Pub. Date: Oct. 22, 2015

(54) METHOD FOR ASSESSING A QUANTITY OF HYDROCARBONS IN A DEPOSIT

(71) Applicant: TOTAL SA, Courbevoie (FR)

(72) Inventors: Patrice Schirmer, Pau (FR); Eric Tawile, Pau (FR); Jacques Clavel, Pau (FR); Tianmeng Hu, Pau (FR); Sung-Bin Ahn, Pau (FR)

(21) Appl. No.: 14/646,373

(22) PCT Filed: Nov. 13, 2013
(86) PCT No.: PCT/FR2013/052734

§ 371 Date: May 20, 2015

(30) Foreign Application Priority Data
Nov. 20, 2012 (FR) 1261045

(51) Int. Cl. G06F 17/50; G06F 17/18

(52) U.S. Cl. CPC G06F 17/5009; G06F 17/18

(57) ABSTRACT

Since the static volume of hydrocarbons in a deposit can be determined using a model built from a group of parameters, several sources of uncertainty are taken into consideration at least some of which are associated with respective parameters of the group. A base case is selected for each source of uncertainty. A probability distribution of the static volume of hydrocarbons is estimated when said source of uncertainty varies while the other sources comply with the base cases thereof. The Monte Carlo approach is used to draw a set of values of volumes from the distributions associated with each source value of volume V_{HCIP} taking into account the impact of the different sources of uncertainties and estimating a distribution of the calculated values of volume VHCIP.

### RELATED APPLICATIONS

The present application is a National Phase entry of PCT Application No. PCT/FR2013/052734 filed Nov. 13, 2013, which claims the benefit of French Application No. 1261045 filed Nov. 20, 2012, which are incorporated herein in its entirety by reference, including the English translation thereof.

### FIELD OF THE INVENTION

The field of the invention is that of subsoil surveys, notably for assessing the quantity of hydrocarbons contained in a reservoir or that it will be possible to extract from such a reservoir.

### BACKGROUND OF THE INVENTION

Assessing and managing the uncertainties of geological models, particularly of models of hydrocarbon reservoirs, is useful for analyzing the risks in the context of hydrocarbon production projects.

The invention relates more particularly to a method for assessing the static volume of hydrocarbons in a deposit, making it possible to quantify the overall uncertainty on this static volume. The invention also relates to a device, a computer program product and a computer-readable medium for implementing such a method.

In the context of the operation of oil deposits, the subsoil in which the hydrocarbon reservoir is located is generally characterized and modeled before any operation thereof. In this context, the construction of a geological model of the hydrocarbon reservoir aims to give an image of the subsoil that is as reliable as possible, in order to estimate the hydrocarbon reserves, i.e. the volume of hydrocarbons which will be able to be extracted, and define a development plan for operation.

Conventionally, several types of modeling are performed: a static modeling generally aims to assess the position, the quantity and the spatial organization of the accumulated hydrocarbons; a dynamic modeling aims to take into account the phenomena which will influence the movements of the fluids, and consequently the volumes of hydrocarbons which will be able to be produced, throughout the production time. The dynamic models are based on production schemes (number of producers/injectors, production time, etc.) which influence the production of hydrocarbons.

These static and dynamic models are constructed from available data relating to the subsoil, which can be quantitative and qualitative data. They are conventionally measurements performed initially on the exploration wells and then on the assessment and development wells (density, porosity, permeability of the rocks, etc.), seismic data, structural, stratigraphic and other such studies. Because these data are of diverse kinds, often imprecise, and/or sparse, and because the modeling involves making hypotheses on the object being modeled, the geological models include uncertainties which have to be taken into account.

The assessment and the management of the uncertainties on these models then constitute a major issue in the context of the operation of hydrocarbon deposits. Quantifying the overall uncertainty on a geological reservoir model, i.e. the uncertainty taking into account all the uncertainties linked to the modeling, helps in assessing the economic risks linked to the operation of a deposit.

It is by virtue of the assessment of the volume taking into account a quantification of the overall uncertainty on each of the static and dynamic models that deterministic models, conventionally called 1P (proven), 2P (probable) or 3P (possible), can be established, and assist in the decision-making process concerning the operation of a deposit.

### SUMMARY OF THE INVENTION

The invention relates in particular to the quantification of the overall uncertainty concerning the static volume of hydrocarbons, in the context of a static modeling of a hydrocarbon deposit.

In this context, the aim of the invention is notably to provide a method that is rapid, reliable and simple to implement, that can be used by operatives other than its designer, to quantify the uncertainty as to the static volume of hydrocarbons of a previously geo-modeled hydrocarbon deposit, which takes account of different uncertainties concerning the properties of the geo-model, and a device for implementing this method.

The present invention proposes a method for assessing the static volume of hydrocarbons in a deposit, wherein the static volume of hydrocarbons can be determined using a model constructed from a group of parameters. A number of mutually independent sources of uncertainty (if necessary after having grouped together mutually dependent sources of uncertainty) are taken into account, at least some of the sources of uncertainty being associated with respective parameters of the group. The method comprises:
selecting a base case for each source of uncertainty taken into account;
determining a reference volume as a static volume of hydrocarbons obtained with the sources of uncertainty in accordance with their respective base cases;
for each source of uncertainty taken into account, estimating a probability law for the static volume of hydrocarbons when said source of uncertainty varies while the other sources of uncertainty conform to their respective base cases;
performing a set of draws of volume values, each draw comprising a respective volume value for each source of uncertainty taken into account, so that the volume values for a given source of uncertainty obey, over all of the draws, the probability law for the static volume of hydrocarbons estimated for said given source of uncertainty;
for each draw, calculating a realization of a volume value V_{HCIP} proportionally to:

$${\prod }_{X} [ 1 + {\sum }_{j = 1}^{{n}_{X}} ( \frac{{V}_{Xj} + {V}_{BC}}{{V}_{BC}} ) ]$$

where V_{BC} is the reference volume, X is a parameter of said group, n_{X} is the number of sources of uncertainty associated with the parameter X, and V_{Xj} is the volume value drawn for the j^{th} uncertainty of the parameter X in said draw; and
estimating a distribution of the calculated volume values V_{HCIP}.

According to one embodiment of the invention, the estimation of the probability law for the static volume of hydrocarbons for a source of uncertainty associated with a parameter of the group comprises:
selecting an unfavorable case and a favorable case for said source of uncertainty;
determining a first static volume of hydrocarbons when said source of uncertainty conforms to its unfavorable case and the other sources of uncertainty conform to their respective base cases;
determining a second static volume of hydrocarbons when said source of uncertainty conforms to its favorable case and the other sources of uncertainty conform to their respective base cases; and
defining said probability law for the static volume of hydrocarbons as a function of the reference volume and of said first and second volumes, for example as a triangular law.

In a particular embodiment, the volume value V_{HCIP} is calculated as being equal to:

$${V}_{BC} \times {\prod }_{X} [ 1 + {\sum }_{j = 1}^{{n}_{X}} ( \frac{{V}_{Xj} + {V}_{BC}}{{V}_{BC}} ) ] .$$

Another embodiment of the invention takes account, among the sources of uncertainty, of the non-ergodicity of a process for determining the static volume of hydrocarbons using the model constructed from the group of parameters. The estimation of the probability law for the static volume of hydrocarbons for the non-ergodicity of the determination process can then comprise:
executing said process several times with all the sources of uncertainty associated with the parameters of said group in accordance with their respective base cases, to determine a set of values of the static volume of hydrocarbons; and
assessing a distribution of the volume values of the set.

The probability law of the volume of hydrocarbons for the non-ergodicity of the determination process can notably be a triangular law estimated by an approximation of said distribution of the volume values.

For a given draw of the volume values, the volume value V_{HCIP} can be calculated as being proportional to:

$${V}_{NE} \times {\prod }_{X} [ 1 + {\sum }_{j = 1}^{{n}_{X}} ( \frac{{V}_{Xj} + {V}_{BC}}{{V}_{BC}} ) ] ,$$

where V_{NE} is the volume value drawn for the non-ergodicity of the determination process in said draw.

One embodiment of the invention further comprises a representation of the impact of the different sources of uncertainty on the volume of hydrocarbons in the form of a tornado diagram comprising a bar representative of the probability law of the static volume of hydrocarbons for each source of uncertainty taken into account, positioned relative to a reference point corresponding to the reference volume.

In a particular case, the bar of the tornado diagram relative to a source of uncertainty has a first extreme point corresponding to a first static volume of hydrocarbons and a second extreme point corresponding to a second static volume of hydrocarbons, the first static volume of hydrocarbons being determined with said source of uncertainty conforming to a selected unfavorable case and the other sources of uncertainty conforming to their respective base cases, and the second static volume of hydrocarbons being determined with said source of uncertainty conforming to a selected favorable case and the other sources of uncertainty conforming to their respective base cases.

The impact can be expressed in an absolute manner in the tornado diagram, the value of the reference point being set at zero, the value of the first extreme point being equal to the deviation between the reference volume and the first volume, and the value of the second extreme point being equal to the deviation between the reference volume and the second volume.

The method makes it possible to rapidly compare, by a visual representation, the impact of the different uncertainties of the properties of the geo-model on the static volume of hydrocarbons.

In a typical embodiment, the group of parameters comprises at least one bulk apparent volume BRV, the ratio between a net apparent volume and the bulk apparent volume NTG, the porosity of the reservoir rock Φ, the hydrocarbon saturation of the reservoir rock S_{H}, and possibly a formation volume factor FVF.

The sources of uncertainty can be linked to the parameters of said group and to properties of a geo-model modeling the hydrocarbon deposit. The parameters and properties are chosen from the following elements: the structure of the deposit, the contact or contacts, the geological bodies within this structure, the facies within the geological bodies, the petro-physical properties of the different types of rocks of the geological bodies, such as the porosity or the saturation, the bulk apparent volume BRV, the ratio between the net apparent volume and the bulk apparent volume NTG, the porosity of the reservoir rock Φ, the hydrocarbon saturation of the reservoir rock S_{H}, the formation volume factor FVF.

Another subject of the invention relates to a device for assessing the static volume of hydrocarbons in a deposit, comprising at least one computation unit configured to execute the steps of a method defined above.

Advantageously, the device according to the invention comprises storage means, computation and parameterizing means, and display and visualization means, for the parameters and their sources of uncertainty, for the volume values estimated and calculated, and for the impact of the sources of uncertainties on the static volume of hydrocarbons.

The device can be used independently of the selected geo-modeling tool.

Another subject of the invention is a computer program product comprising code elements for executing the steps of the method according to the invention, when said program is run by a computer. A final subject of the invention is a computer-readable medium on which is stored this computer program product.

The invention will be better understood from the following description, given as a nonlimiting example with reference to the attached drawings.

### BRIEF DESCRIPTION OF THE DRAWINGS

FIG. 1 is a general flow diagram of a method for assessing hydrocarbon reserves, that can include the execution of a method according to the invention.

FIG. 2 is a flow diagram illustrating a method for assessing the static volume of hydrocarbons of a deposit.

FIGS. 3A and 3B represent a hydrocarbon deposit of the geo-modeled subsoil. FIG. 3A schematically represents a cross-sectional view of the subsoil containing a hydrocarbon deposit. FIG. 3B represents a 3D image of the structure of a geo-modeled hydrocarbon reservoir.

FIG. 4 shows a tornado diagram used in an embodiment of the method for assessing the static volume of hydrocarbons.

FIG. 5 is a graph illustrating unfavorable, favorable and base cases of a source of uncertainty linked to the water saturation.

FIG. 6 is an exemplary tornado diagram that can be used in an embodiment of the method for assessing the static volume of hydrocarbons.

FIG. 7 is an exemplary histogram recording the volumes found by the calculation in a number of determinations of the static volume of hydrocarbons with the parameters of the model set to their base cases, in an analysis of ergodicity performed in certain embodiments of the method for assessing the static volume of hydrocarbons.

FIG. 8 is a graph illustrating one way of choosing the quantile of a source of uncertainty as a function of a quantile targeted for the static volume of hydrocarbons when the probability law associated with this source of uncertainty is a uniform law.

FIG. 9 is a graph similar to that of FIG. 8 in the case of a triangular probability law.

FIG. 10 is a flow diagram of a method for extracting quantiles used in constructing a single model to represent a hydrocarbon reservoir.

FIG. 11 illustrates a simplified example with a tornado diagram with two bars.

FIG. 12 shows an exemplary user interface of a device according to the invention.

### DETAILED DESCRIPTION OF THE DRAWINGS

### Definitions

The following definitions are given by way of examples for interpreting this presentation.

Hydrocarbon reservoir or hydrocarbon deposit should be understood to mean an area of the subsoil where hydrocarbons are concentrated, such as gas or oil, conventionally reservoir rocks having a certain porosity, in which hydrocarbons are trapped.

Geo-model of a hydrocarbon deposit should be understood to mean a geological model of the subsoil comprising a hydrocarbon reservoir, which makes it possible to estimate the static volume of hydrocarbons. The geo-model is constructed from a group of parameters linked to properties that make it possible to describe the hydrocarbon reservoir, and which correspond mainly to geometrical properties of the reservoir and petro-physical properties of the constituent parts of the reservoir (geological facies, nature and properties of the hydrocarbons, etc.). The parameters used to construct the geo-model are not perfectly known, but estimations thereof can be made available from measurements conducted in the field.

Static volume of hydrocarbons should be understood to mean the total volume of hydrocarbons initially in place in the reservoir rocks. This static volume differs from the volume of reserves corresponding to the volume of hydrocarbons which can be extracted from the subsoil. The static volume of hydrocarbons is expressed typically, in the context of a static modeling, as the product of parameters linked to the properties of the geo-model. According to the present description, a parameter of the static volume can also be a property of the geo-model.

Source of uncertainty should be understood to mean an element which influences a given parameter or property, such that the latter exhibits a variation as a function of said element, inducing an uncertainty concerning the parameter or the property.

One source of uncertainty that the method presented here can further take into account is the non-ergodicity of the process for determining the static volume of hydrocarbons using the geo-model.

In the present description, a distinction is drawn between a direct source of uncertainty and an indirect source of uncertainty, depending on whether it directly or indirectly influences a parameter involved in modeling the static volume of hydrocarbons. Indirect influence on a parameter should be understood to mean the influence of the parameter through an intermediate quantity, for example a property of the geo-model, which varies as a function of the indirect source of uncertainty. Such is, for example, the case of the BRV parameter representing the apparent volume, i.e. the volume of rocks above the water-hydrocarbon contact, which is one of the parameters used to calculate the static volume of hydrocarbons. The BRV parameter generally comprises a number of indirect sources of uncertainties: this parameter generally expresses various properties of the geo-model relating to the structure of the reservoir, notably the “water/hydrocarbons contact” property representing the position of the water/hydrocarbons contact in the subsoil that is modeled. This “contact” property can comprise one or more sources of uncertainty causing the contact between two extreme values to vary. These sources of uncertainties, causing the “contact” property to vary, are therefore considered here to be indirect, in that they “indirectly” influence the BRV parameter.

A source of uncertainty can comprise a number of dependent sources of uncertainty, i.e. a number of sources of uncertainty which have a correlated influence on a given parameter or property.

Base case should be understood to mean a base case of the geological model of the hydrocarbon deposit. This base case is generally chosen by a person executing the method or an expert cooperating with this person, according to the geological model of the deposit that is considered to be most credible. The expression base case is used, in the present description, with reference to the static volume of hydrocarbons, with reference to a property of the geo-model of the deposit, with reference to a parameter modeling the static volume, or with reference to a source of uncertainty. The volume of the base case is a reference volume estimated when the properties of the geo-model, the parameters expressing the static volume, and the sources of uncertainty are chosen according to their base case.

Unfavorable case/favorable case should be understood to mean an unfavorable/favorable case of the geological model of the hydrocarbon deposit, i.e. a case in which the static volume of hydrocarbons is less than/greater than the volume of the base case. Reference can be made to the unfavorable/favorable case in relation to the static volume of hydrocarbons, to a parameter, to a property or to a source of uncertainty, in the present description. When, for example, reference is made to the unfavorable/favorable case for a property of the geo-model, the latter corresponds to a value or configuration of said property for which the static volume of hydrocarbons is less than/greater than the volume of the base case.

### Estimation of Reserves

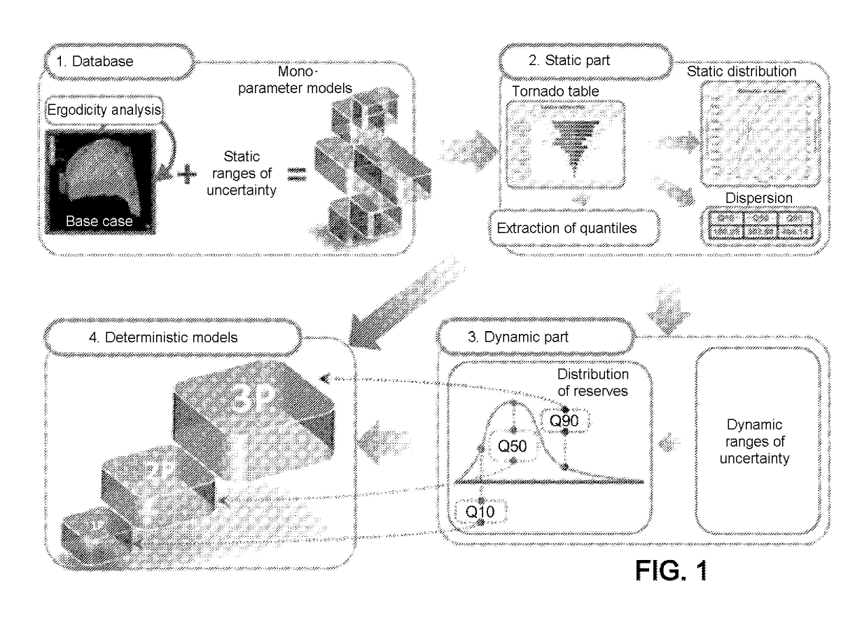

FIG. 1 illustrates the general method used to estimate the reserves of hydrocarbons that can be extracted from a deposit. Four phases are distinguished:
1. the construction of static reservoir models, from input data comprising, for various static parameters, the base cases chosen by the user and associated uncertainty bands in the form of favorable and unfavorable cases;
2. the determination of a distribution (probability law) of the static volume of hydrocarbons from the different models for which the uncertainties can be represented using a tornado diagram;
3. the determination of a distribution (probability law) of the reserves of hydrocarbons that will be able to be extracted by additionally taking into account the uncertainties concerning the dynamic parameters relating to the flow of hydrocarbons during production (permeability of the rocks, viscosity of the hydrocarbons, etc.);
4. the construction of deterministic models of the subsoil, which will be able to be used to assess the dynamic uncertainties concerning the reserves.

In general, interest is focused on deterministic models 1P, 2P or 3P corresponding to the quantile 10, 50 or 90 of the distribution of the reserves (Q10, Q50, Q90). For example, a 1P model is an exemplification of the structure and of the composition of the subsoil making it possible to extract a volume of hydrocarbons equal to the proven reserves, i.e. having a 90% chance of being extracted according to the distribution of the reserves.

### 3D Static Model and Expression of the Volume of Hydrocarbons

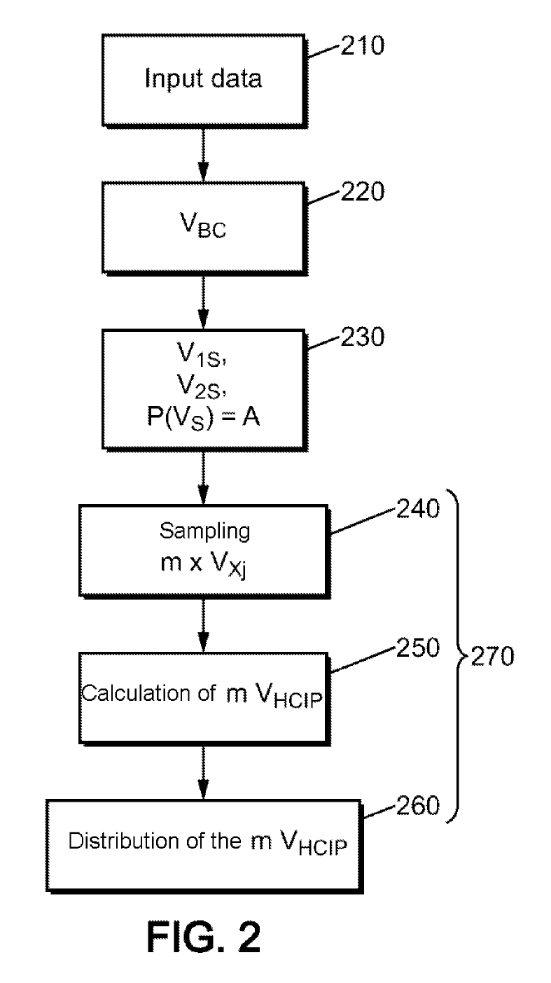

The method for assessing the distribution of the static volume uses, as input data 210 (“input data” in FIG. 2), the elements involved in a static modeling of the hydrocarbon deposit, defined by a set of properties chosen so as to best represent the subsoil in which the potential deposit is located. This generally involves a three-dimensional (3D) numerical modeling based on properties relating to the geometry and to the petro-physical properties of the deposit. The objective of this modeling is notably to assess the static volume of hydrocarbons in the deposit.

The modeling relies itself on initial data of various kinds, for example seismic data, cartographic readings, data concerning the rock formations and the structure of the subsoil obtained from geological surveys, data from exploration drillings (e.g. chemical and mineralogical analyses of the cuttings brought up during the drilling, data from well logs: porosity, density, temperature, pressure, water and/or hydrocarbon content, permeability, resistivity, radioactivity, velocity of the P waves, etc.). These initial data make it possible to estimate all the properties chosen for the modeling. The modeling is produced using geo-modeling software, which can have been custom-developed, or as available on the market.

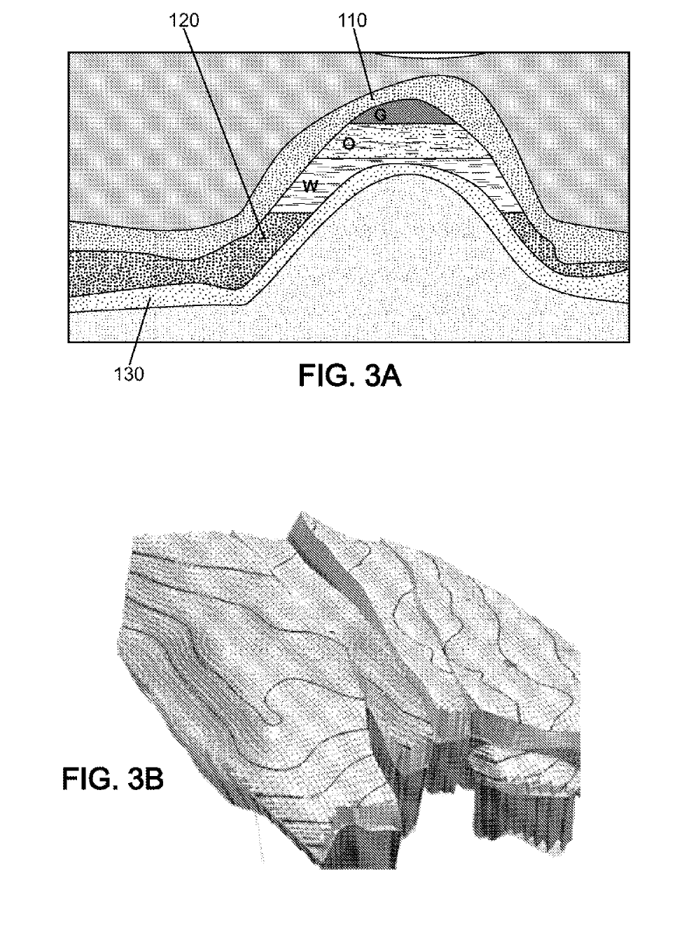

A 3D numerical static model of the deposit is, for example, defined by the following elements: the structure of the deposit, the geological bodies within this structure, the types of rocks within the geological bodies, the petro-physical properties of the different types of rocks of the geological bodies (e.g. porosity, water and hydrocarbon saturation). FIG. 3A schematically illustrates the structure of a subsoil comprising a hydrocarbon deposit. A deposit is conventionally formed in the subsoil from a source rock 130, initially containing gas, water and oil, and in which there occurs a primary migration of the fluids, during which the gas expels the water and the oil toward a porous geological formation. This formation constitutes the reservoir rock 120, within which a secondary migration of the fluids takes place toward the surface. The fluids (gas G, oil O and water W) are then trapped in the reservoir rock topped by an impermeable cap rock 110.

FIG. 3B is a 3D image of the geo-model of a hydrocarbon deposit, showing more particularly a possible geological structure thereof. As can be seen in FIG. 3B, the 3D model is meshed and formed by a multitude of individual 3D cells, representing, in the space, the hydrocarbon reservoir. The image of this FIG. 3B reveals topographical lines on the top of the reservoir, the different layers internal to the reservoir, and their thicknesses, and structural discontinuities in the reservoir corresponding to a system of faults.

From the knowledge of such a static model, the static volume of hydrocarbons V_{HCIP}, or volume of hydrocarbons in place (HCIP), can be determined according to the following equation:

V_{HCIP}=BRV×NTG×Φ×S_{H}×FVF (I)

in which:
BRV (Bulk Rock Volume) is the bulk apparent volume, i.e. the volume of rocks above the water-hydrocarbon contact denoted C in FIG. 3A;
NTG (Net to Gross) is the ratio between the net apparent volume and the bulk apparent volume, between 0 and 1, i.e. the proportion of BRV formed by the reservoir rock where the hydrocarbons are concentrated;
Φ is the porosity of the reservoir rock;
S_{H} is the hydrocarbon saturation of the reservoir rock;
FVF is the formation volume factor, i.e. the factor of conversion of the volume of hydrocarbons in the conditions (pressure and temperature) of the reservoir into a volume of hydrocarbons in the surface conditions (atmospheric pressure and temperature), which takes into account the phenomena of contraction/expansion of the hydrocarbons upon their extraction from the subsoil.

The method presented here is not necessarily applicable with only this one expression of the volume according to these five parameters. Other parameters could optionally be taken into account in calculating the volume.

### Uncertain Properties and Parameters—Sources of Uncertainty

The initial data on which the modeling of the deposit is based have an uncertain nature. This can be due to the uncertainties concerning the well measurements (number of measurements, number and location of the wells), errors in interpreting well measurement results or geological surveys, etc. Because of this, the properties of the geo-model and the parameters used to estimate the static volume of hydrocarbons are generally uncertain properties and parameters.

The modeling itself entails making hypotheses, the aim of which is to simplify the modeled object. It generally takes into account information of a statistical nature, by using variograms or entrainment images in the multipoint geo-modeling. Consequently, the modeling method can also contribute to the uncertainty as to the assessed static volume of hydrocarbons.

The group of parameters making it possible to determine the static volume of hydrocarbons comprises uncertain parameters, associated with sources of uncertainty. A source of uncertainty can be direct in the case where it directly influences the parameter. Such is the case of the reservoir rock porosity parameter, for example, which can vary according to a number of sources of uncertainty, such as the number of wells, the interpretation of the measurements, the correction of the coverage effect (“overburden”), etc. The porosity constitutes both a parameter used to assess the static volume, but also a property of the geo-model. The element which then influences the porosity is a direct source of uncertainty, in that there is no variable intermediate quantity that the element influences, and which would itself influence the porosity. The source of uncertainty can also be indirect in the case where it influences the parameter via another quantity, which varies as a function of this source of uncertainty.

The bulk apparent volume BRV, net to gross ratio NTG, porosity Φ, hydrocarbon saturation So, and volume form factor FVF parameters can have one or more sources of uncertainty, including, for each of the parameters:
the bulk apparent volume parameter BRV: this parameter is generally determined from the mapping and the correlation of sedimentary formations. Depending on the accuracy of the cartographic data, of the stratigraphic logs, of the seismic measurements and their interpretation, the bulk apparent volume parameter BRV can vary as a function of the following uncertain properties: the structure of the reservoir, the spatial position of the contacts between fluids (water/hydrocarbon contacts), the geological bodies (position and geometry), the nature of the facies of the geological bodies and their proportions;
the net to gross ratio NTG parameter: this parameter is generally estimated from well log measurements. The sources of uncertainty associated with this parameter can, nonexhaustively, be as follows: the measurement, the interpretation of the measurement, the representative nature of the wells, the overburden, the cutoff performed on the measurement, the effect of the compaction, the regional trends, the variogram used in the interpolation method;
the porosity parameter Φ: this parameter is, as a general rule, also estimated from well log measurements, and/or by analogy with similar rocks of known porosity. The sources of uncertainty for this parameter can notably be: the number and the dispersion of the wells where the measurements are performed, the representative nature of the wells, the interpretation of the measurement, the overburden correction, the choice of cutoff;
the hydrocarbon saturation parameter So: the estimation of the hydrocarbon saturation of the reservoir rock is derived from well logs. Consequently, the main source of uncertainty for this parameter lies essentially in the measurement of the saturation;
the volume form factor parameter FVF, the main uncertainty of which is linked to the interpretation of the data.

It will be apparent to those skilled in the art that sources of uncertainty other than those mentioned by way of illustration in this description can be taken into account.

The different sources of uncertainty are considered to be mutually independent. If at the outset there are a number of dependent, i.e. correlated, sources of uncertainty, they are grouped together to form one source of uncertainty taken into account in the method.

For each source of uncertainty, there is an associated base case, an unfavorable case and a favorable case. The base, unfavorable and favorable cases are typically chosen by a user. The base case of a source of uncertainty can be defined as corresponding to the value of the parameter associated with the source of uncertainty concerned, which is the most credible for the user given the source(s) of uncertainty concerning said parameter. In the case of an indirect source of uncertainty, the base case corresponds to the configuration of the property associated with the source of uncertainty concerned, which is the most credible for the user. Thus, it is possible to define, using all the sources of uncertainty chosen according to their base case, the base case of the geological model of the hydrocarbon deposit, also called reference geo-model in the present description, i.e. the geological model of the deposit that is most credible for the geologist. The unfavorable case of a source of uncertainty corresponds to a case for which the value of the parameter associated with the source of uncertainty concerned, or the configuration of the property of the geo-model, leads to a static volume less than that associated with the base case. The favorable case of a source of uncertainty is defined in the same way, except that in this case the static volume is greater than that of the base case.

### Estimation of a Reference Volume

A first step 220 of the method illustrated in FIG. 2 consists in determining a reference volume V_{BC} as a static volume of hydrocarbons when the sources of uncertainty are all chosen according to their base case.

As explained above, the set of base cases of the sources of uncertainty makes it possible to establish the base case of the geological model of the hydrocarbon reservoir.

In practice, the base case is constructed by the user, for example a geologist, according to his or her general knowledge concerning the hydrocarbon deposits applied to a particular case: there is thus determined a base case configuration for each property of the geo-model, and/or a base case value for each parameter involved in calculating the static volume according to the above equation (I). The model is meshed and the total volume is the sum of the volumes of each cell containing hydrocarbons. The volume of these cells is obtained by applying the equation (I), each parameter being defined because each cell belongs exclusively to a sedimentary body, to a type of rock, etc. Thus, a static volume of hydrocarbons, called reference volume or base case volume V_{BC}, is then determined according to the equation (I). No uncertainty is taken into account in producing the reference model or “base case” model. During this step, the operator uses, for example, the geo-modeling software which makes it possible to produce the 3D model of the reservoir according to the base case, and to automatically determine the associated reference volume.

### Impact of each Source of Uncertainty on the Static Volume of Hydrocarbons

In a second step 230 of the method illustrated in FIG. 2, three operations, described hereinbelow, are carried out for each source of uncertainty S taken into account.

A first operation consists in estimating a first static volume of hydrocarbons V1_{S} when the source of uncertainty S is chosen according to its unfavorable case and the other sources of uncertainty are chosen according to their base case. In practice, the geologist chooses an unfavorable case of the source of uncertainty: he or she chooses a value of the parameter associated with the source of uncertainty concerned, which leads to a static volume less than that associated with the base case. In the case of an indirect source of uncertainty, it is the value of the intermediate quantity, generally corresponding to a given configuration of the property of the geo-model, which is chosen such that the static volume is less than that associated with the base case. To make this choice, analog studies, expert appraisals concerning the site being explored, or any other information deriving for example from earlier studies on the site are, for example, taken into account. A “single-parameter run” is then performed, in other words a 3D static model of the reservoir is produced, using the geo-modeling software, in which the value of the parameter or the configuration of the property associated with a given source of uncertainty is set according to its unfavorable case, and all the other values of the parameters or configurations of the properties of the geo-model are set according to their base case. A first static volume of hydrocarbons V1_{S} is thus calculated according to the equation (I).

A second operation consists in estimating a second static volume of hydrocarbons V2_{S} when the source of uncertainty S is chosen according to its favorable case and the other sources of uncertainty are chosen according to their base case. In this second operation, the method is conducted in the same way as in the first operation, except that the favorable case replaces the unfavorable case. Thus, a value of the parameter associated with the source of uncertainty concerned is chosen, or a configuration of the property associated with said source of uncertainty is produced, such that the static volume is greater than that associated with the base case.

A third operation lies in the assignment of a probability law P to the source of uncertainty S, as a function of the reference volume V_{BC}, and first and second volumes V1_{S} and V2_{S}. Any probability law can, in theory, be assigned to the source of uncertainty. The choice of the type of the probability law depends on the geological hypotheses formulated for the modeling of the reservoir. The assignment of the probability law for each source of uncertainty is performed by the user. As for the choice of the favorable and unfavorable cases, the user can choose the type of probability law to be associated with a given source of uncertainty, for example according to analog surveys, appraisals, earlier studies, etc.

Alternatively, this assignment is performed automatically by the computer program, for example with a triangular law.

The choice of the probability law is specific to each source of uncertainty. It depends on the volumes V1_{S} and V2_{S} of the unfavorable and favorable cases retained for this source. Probability laws other than triangular, such as a log-normal law, a uniform law, a normal law or a beta law can also be used. The user may be offered, by the program, a number of possible choices of mathematical forms of the probability laws for all of the sources of uncertainty or source by source.

For each source of uncertainty, the first static volume V1_{S} corresponds to a probability quantile associated with the unfavorable case, and the second static volume V2_{S} corresponds to a probability quantile associated with the favorable case. These quantiles can be chosen by the user of the method.

For example, the unfavorable case corresponds to the probability quantile 0 (Q0), and the favorable case corresponds to the probability quantile 100 (Q100). Thus, for a given source of uncertainty, the unfavorable case corresponds to a minimum static volume value associated with a first extreme value of the parameter, or a first extreme configuration of the property linked with this source of uncertainty, and the favorable case corresponds to a maximum static volume value associated with a second extreme value of the parameter, or a second extreme configuration of the property linked with this source of uncertainty. If a triangular probability law is adopted for the source concerned, giving rise to first and second static volumes V1_{S}, V2_{S}, this law is then defined by:

$$P ( {V}_{S} ) = 0 for {V}_{S} \leq V {1}_{S} or {V}_{S} \geq V {2}_{S} ; \\ P ( {V}_{S} ) = \frac{2 ( {V}_{S} - V {1}_{S} )}{( {V}_{BC} - V {1}_{S} ) ( V {2}_{S} - V {1}_{S} )} for V {1}_{S} \leq {V}_{S} \geq {V}_{BC} ; and \\ P ( {V}_{S} ) = \frac{2 ( V {2}_{S} - {V}_{S} )}{( V {2}_{S} - {V}_{BC} ) ( V {2}_{S} - V {1}_{S} )} for {V}_{BC} \leq {V}_{S} \geq V {2}_{S} . \qquad ( II )$$

Another possibility is to provide for the unfavorable case to correspond to the probability quantile α (for example Q10 when α=10%), and for the favorable case to correspond to the probability quantile 100−α (for example Q90 when α=10%) for each source of uncertainty.

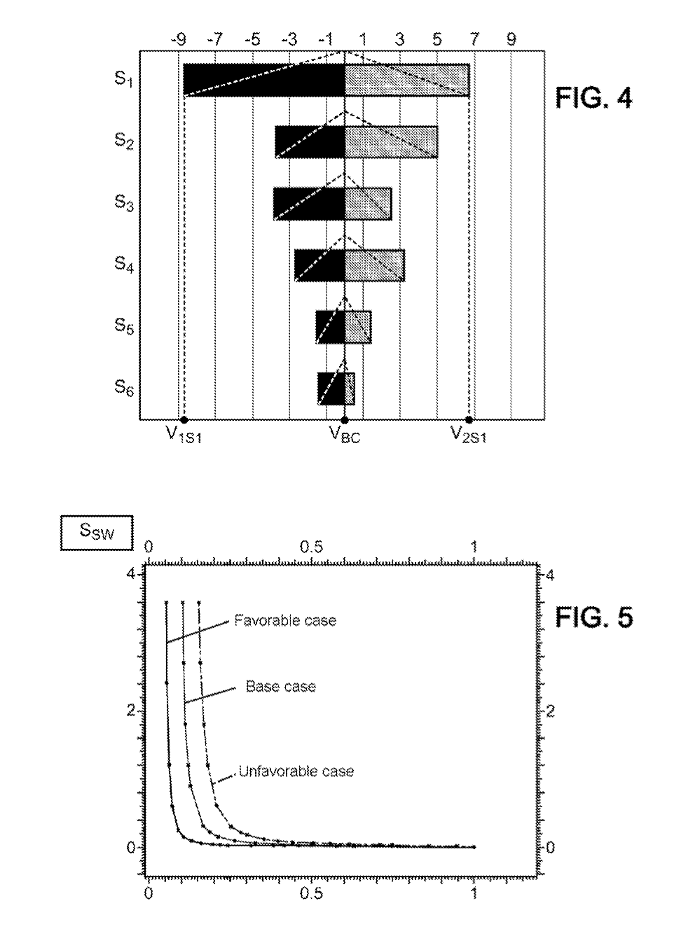

Advantageously, the method allows for the representation of the impact of each source of uncertainty on the static volume of hydrocarbons. Thus, according to an advantageous embodiment, this representation is produced in the form of a tornado diagram, which enables the user to visualize the impact of each source of uncertainty on the static volume of hydrocarbons and thus easily assess the parameters with the most influence in terms of uncertainty on the static model. FIG. 4 illustrates such a representation of the impact of the uncertainties in tornado diagram form. The tornado diagram comprises horizontal bars ranked vertically according to their size, generally from the largest bar, representing the greatest impact, at the top of the diagram, to the smallest bar at the bottom of the diagram, culminating in the conventional tornado form of these diagrams. Each bar of the tornado diagram corresponds to a direct or indirect source of uncertainty S, i.e. a source of uncertainty of a parameter modeling the static volume or of a property of the geo-model. Each bar is constructed from a central point, which corresponds to the reference volume V_{BC}, a first extreme point corresponding to the first static volume of hydrocarbons V1_{S}, and a second extreme point corresponding to the second static volume of hydrocarbons V2_{S}.

In FIG. 4, the broken lines illustrate the probability laws, in this case triangular, aligned on the quantiles Q0 and Q100 for each source of uncertainty, retained for the static volume of hydrocarbons.

The user can choose the values of the static volumes V1_{S} and V2_{S} and the probability quantile associated with V1_{S} and V2_{S}, and input these values manually via a graphical interface of a computer program intended for the implementation of the method. This graphical interface advantageously comprises cells in which are respectively input, for each source of uncertainty, the values of the static volumes and the associated probability quantiles.

The tornado diagram represents the impact of each source of uncertainty on the static volume of hydrocarbons in an absolute manner. The value of the central point is for example set at zero, the value of the first extreme point is equal to the deviation between the first volume V1_{S} and the reference volume V_{BC} (i.e. V1_{S}−V_{BC}), while the value of the second extreme point is equal to the deviation between the second volume V2_{S} and the reference volume V_{BC} (i.e. V2_{S}−V_{BC}). This representation is generally preferred for the user interpreting the data, because of the direct visualization of the deviations expressed in terms of volume. Alternatively, the tornado diagram represents the impact in a relative manner, with, for each bar:
the value of the central point (V_{BC}) equal to 1;
the value of the 1^{st} extreme point equal to

$$( 1 + \frac{( V {1}_{S} - {V}_{BC} )}{{V}_{BC}} )$$

the value of the 2^{nd} extreme point equal to

$$( 1 + \frac{( V {2}_{S} - {V}_{BC} )}{{V}_{BC}} )$$

### Quantifying the Overall Uncertainty as to the Static Volume of Hydrocarbons

After the step 230, a step 270 consists in quantifying the overall uncertainty as to the static volume of hydrocarbons, by taking into account sources of uncertainty associated with the parameters modeling the static volume.

In a first step, a sampling (substep 240) is performed in the distributions of volume values for the different sources of uncertainty. For each sample, made up of as many values as there are sources of uncertainty taken into account in the method, a static volume of hydrocarbons V_{HCIP} is calculated (substep 250).

In a second step (substep 260), a distribution of the static volume of hydrocarbons is established from the volumes V_{HCIP} calculated in the substep 250, which makes it possible to quantify the overall uncertainty as to the static volume of hydrocarbons of the deposit.

### Sampling of Volume Values in the Volume Distributions for each Source of Uncertainty

The sampling 240 consists in performing a set of m draws of volume values. Each draw comprises a respective volume value for each source of uncertainty. These draws are performed in such a way that the volume values for a given source of uncertainty obey, over all the draws, the probability law of the static volume of hydrocarbons defined for this given source of uncertainty, in the manner of a Monte Carlo method.

Considering that the number of sources of uncertainty S taken into account is equal to M_{S}, each draw or sample is thus made up of M_{S} values, and the sampling results in a set of m samples. The total number of samples m is great, for example several thousand, and the draws are performed randomly, observing the probability laws associated with the sources of uncertainty.

### Calculation of the Static Volume V_{HCIP} for each Sample and Estimation of the Distribution of the Calculated Volume Values V_{HCIP}

From each sample derived from the sampling 240, in the substep 250, a static volume of hydrocarbons is calculated according to the following equation (III):

$${V}_{HCIP} = β \times {\prod }_{X} [ 1 + {\sum }_{j = 1}^{{n}_{X}} ( \frac{{V}_{Xj} - {V}_{BC}}{{V}_{BC}} ) ] \qquad ( III )$$

in which X is a parameter of the group of parameters modeling the static volume of hydrocarbons, n_{X} is the number of sources of uncertainty associated with the parameter X (n_{X}≧1 if there is at least one source of uncertainty associated with this parameter), V_{Xj} is the volume value drawn for the j^{th} uncertainty of the parameter X in the sample concerned, and β is a proportionality coefficient.

The approximation is made, for the calculation of the static volume according to the equation (I), to take each parameter X modeling the static volume of hydrocarbons equal to its base case value plus a correction proportional to V_{Xj}−V_{BC} for each source of uncertainty j, which constitutes a reasonable hypothesis. The equation (III) expresses this hypothesis.

The equation (III) can also be written in the following form (IV):

$${V}_{HCIP} = β \times {\prod }_{X} [ {\sum }_{j = 1}^{{n}_{X}} ( 1 + \frac{( {V}_{Xj} - {V}_{BC} )}{{V}_{BC}} ) - ( {n}_{X} - 1 ) ] \qquad ( IV )$$

In this form, the equation highlights the impact, expressed relatively, of each source of uncertainty j associated with a given parameter X. It thus appears that the calculation of a static volume V_{HCIP} can advantageously be performed by implementing the very simple steps 220 and 230, for example in the form of a tornado diagram representing the impact of each source of uncertainty on the static volume of hydrocarbons, and by implementing the sampling according to the step 240, which thus allows for a simple and rapid calculation of numerous values of V_{HCIP}, culminating in the establishment of a distribution of the volume values V_{HCIP}.

In this equation (IV), the impact of all the sources of uncertainty of all the parameters for modeling the static volume of hydrocarbons is advantageously taken into account. The impact of each source of uncertainty for a given parameter X is expressed in a relative form. The relative term

$$1 + \frac{( {V}_{Xj} - {V}_{BC} )}{{V}_{BC}}$$

corresponds to a bar in a tornado diagram. Thus, the formula (IV) advantageously allows the method to be based on a minimum of data, simple to establish from a geo-model (V_{BC}, V1_{S}, V2_{S}, and probability law P specific to each source of uncertainty S), and preferably represented in a tornado diagram which offers the additional benefit of allowing for a rapid visual comparison of the impact of each source of uncertainty, to culminate in a rapid and robust probabilization of the static volume of hydrocarbons.

In an embodiment in which only the uncertainties concerning the different parameters X are taken into consideration, the coefficient β of the equation (III) is taken to be equal to the reference volume V_{BC}, such that the equation (III) can be written:

$${V}_{HCIP} = {V}_{BC} \times {\prod }_{X} [ 1 + {\sum }_{j = 1}^{{n}_{X}} ( \frac{{V}_{Xj} - {V}_{BC}}{{V}_{BC}} ) ] \qquad ( {III}^{′} )$$

### EXAMPLE

The following example is given as an illustrative and nonlimiting example. A geo-model of an oil-bearing deposit area takes into account the following properties:
the structure of the reservoir;
twelve sedimentary geological bodies identified “Aes”: AE1 (hemipelagite), AE2 (ridge of schistose limonite type), AE3 (weakly sandy ridge), AE4 (highly sandy ridge), AE5 (deposit channel), AE6 (line of erosion-construction of the channel), AE7 (stream of argillaceous debris), AE8 (stream of sandy debris), AE99a (margin of the highly sandy lobe), AE1212a (central lobe);
ten facies “AFs” associated with the sedimentary bodies Aes: AF1 (hemipelagite), AF2 (ridge/fringe of the schistose limonite lobe), AF3 (ridge/fringe of the weakly sandy lobe), AF4 (highly sandy ridge), AF5 (filling of the deposit channel), AF6 (filling of the line of erosion-construction of the channel), AF7 (stream of argillaceous debris), AF8 (stream of sandy debris), AF9 (margin of the highly sandy lobe), AF12 (central lobe);
the water saturation S_{W};
the porosity Φ;
the net to gross ratio NTG;
the position of the contact.

Some of the properties of the geo-model correspond also to the parameters modeling the static volume of hydrocarbons according to the equation (I). Here, these are the porosity Φ, the net to gross ratio NTG, and indirectly the water saturation S_{W} (S_{H}=1−S_{W}).

The sources of uncertainties taken into account in this example are as follows:
a source of uncertainty called “S_{Petro}”, which combines sources of uncertainty dependent on the average of the net to gross ratio NTG and on the net porosity distributions Φ;
a source of uncertainty called “S_{AE}” which reflects the lateral variation of the geological bodies determined from seismic data;
a source of uncertainty called “S_{AF}” which reflects the variation of the proportions of facies in the geological bodies, and which is linked to the measurement, and the interpretation, of well data from the area being studied, and to the comparison with analogs situated in one and the same geographic area;
a source of uncertainty called “S_{Thickness}” which reflects the variation of thickness of the reservoir rock, and which is linked to the method of interpolation by kriging the well data and to the analysis of the associated variogram;
a source of uncertainty called “S_{SW}”, which reflects the variation of the water saturation, and which is linked to the use of an analog to estimate the water saturation. An uncertainty of 5% is applied according to this analog;
a source of uncertainty called “S_{Contact}”, which reflects the variation of the spatial limits of the water/hydrocarbon contacts.

The sources S_{Petro}, S_{AF}, S_{AE}, S_{Thickness}, S_{SW} and S_{Contact} are independent sources of uncertainties, each being associated with a parameter modeling the static volume and/or a property of the geo-model. The sources of uncertainties S_{AF}, S_{AE}, S_{Thickness} and S_{Contact} are indirect sources of uncertainties, in that they are linked to the parameter BRV of the static lo volume of the equation (I) via the following quantities: position of the geological bodies, proportions of the facies in the geological bodies, thickness of the reservoir and position of the contacts between the fluids. The source of uncertainty S_{Petro} is a direct source of uncertainty in that it is directly associated with the parameters of the porosity volume Φ and net to gross ratio NTG. The same applies for the direct source of uncertainty S_{SW} which directly influences the hydrocarbon saturation parameter. The volumic parameter FVF, which makes it possible to transform the bottom volumes into surface volumes, is not used if the volumes used are the bottom volumes.

In a first step, a base case of the geo-model is defined by the geologist, in which a given value and/or configuration is assigned to each of the properties of the geo-model and the parameters modeling the static volume of hydrocarbons according to the equation (I). A reference volume is then estimated, and corresponds to the static volume of hydrocarbons when the sources of uncertainty are chosen according to their base case. For this, a realization of the 3D model is produced, for example using the Petrel E&P software from Schlumberger, in which all the values/properties are at base case. The reference volume V_{BC} is equal to 25.1 Mm³ in this example.

For each source of uncertainty, the geologist determines a favorable case and an unfavorable case. Table 1 (S_{Petro}, S_{Thickness}, S_{Contact}) indicates examples of values and of configurations of the parameters and properties linked to certain sources of uncertainty according to their favorable and unfavorable case. In the case of the source of uncertainty S_{Petro}, two parameters are associated with this source of uncertainty: the porosity and the NTG ratio vary in the same way according to this source of uncertainty. Different values are chosen for five different facies out of the ten, for which these parameters are likely to vary, the other facies not being used for the reservoir concerned. FIG. 5 illustrates the base, unfavorable and favorable cases chosen for the source of uncertainty S_{SW}.

TABLE 1

| Source of | Parameter/ | | Unfavorable | Favorable | |
|---|---|---|---|---|---|
| uncertainty | property | Facies | case | case | Base case |
| S_{Petro} | Porosity | AF3 | 0.15 | 0.21 | 0.18 |
| | | AF4 | 0.16 | 0.22 | 0.19 |
| | | AF5 | 0.24 | 0.29 | 0.27 |
| | | AF6 | 0.20 | 0.29 | 0.27 |
| | | AF12 | 0.23 | 0.30 | 0.26 |
| | NTG | AF3 | 0.18 | 0.35 | 0.28 |
| | | AF4 | 0.30 | 0.50 | 0.36 |
| | | AF5 | 0.75 | 0.95 | 0.86 |
| | | AF6 | 0.55 | 0.95 | 0.86 |
| | | AF12 | 0.80 | 0.97 | 0.87 |

| | | | |
|---|---|---|---|
| S_{Contact} | 3220 | 3270 | 3250 |

For each source of uncertainty, two single-parameter runs are performed, one for the favorable case and another for the unfavorable case. Thus, there are defined, for each source of uncertainty j, a first and a second static volume of hydrocarbons V1_{S} and V2_{S}, when the source of uncertainty j is chosen respectively according to its unfavorable case and according to its favorable case, and the other sources of uncertainty are chosen according to their base case.

Table 2 below presents the volume values of the favorable case (“case F”) and unfavorable case (“case U”) for each source of uncertainty, as well as the impact expressed in an absolute manner, i.e. the deviation between V1_{S} or V2_{S} and the reference volume V_{BC}, in a relative manner

$$( 1 + \frac{( {V}_{S} - {V}_{BC} )}{{V}_{BC}} ) .$$

The probability quantiles 10 and 90 or 0 and 100 are assigned respectively to the unfavorable and favorable cases, for each source of uncertainty. This assignment is made by the geologist. The “ID” column gives the amplitude of the impact in relative terms

$$( \frac{( V {2}_{S} - V {1}_{S} )}{{V}_{BC}} ) .$$

TABLE 2

| | | | Impact | | Impact | | | | |
|---|---|---|---|---|---|---|---|---|---|
| Source of | Volume | | (absolute) | | (relative) | | Quantiles | | ID |
| uncertainty | Case U | Case F | Case U | Case F | Case U | Case F | Case U | Case F | (%) |
| S_{Petro} | 16.4 | 31.8 | −8.70 | 6.70 | 0.65 | 1.27 | 10 | 90 | 61.35 |
| S_{AF} | 21.4 | 30.1 | −3.70 | 5.00 | 0.85 | 1.20 | 10 | 90 | 34.66 |
| S_{AE} | 21.3 | 27.6 | −3.80 | 2.50 | 0.85 | 1.10 | 0 | 100 | 25.10 |
| S_{Thickness} | 22.4 | 28.3 | −2.69 | 3.18 | 0.89 | 1.13 | 10 | 90 | 23.38 |
| S_{SW} | 26.6 | 26.5 | −1.50 | 1.40 | 0.94 | 1.06 | 10 | 90 | 11.55 |
| S_{Contact} | 26.7 | 25.6 | −1.40 | 0.50 | 0.94 | 1.02 | 10 | 90 | 7.57 |

A triangular probability law is defined for each source of uncertainty, as a function of V_{BC} (the mode), V1_{S} and V2_{S}.

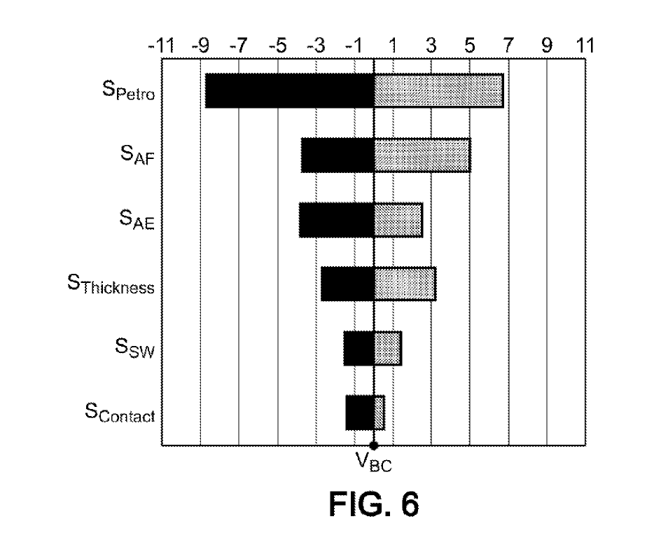

A tornado diagram is constructed on the basis of the data estimated for each source of uncertainty, which can be seen in FIG. 6.

A sampling is then performed during which volume values are drawn randomly from the distributions of the different sources of uncertainties. Each sample (or draw) comprises 6 volume values: a value drawn from the distribution of each of the 6 sources of uncertainty. The draw is performed in such a way that the volume values for a given source of uncertainty obey, over all the draws, the triangular probability law of the static volume defined for this source of uncertainty.

A static volume of hydrocarbons V_{HCIP} is calculated for each sample according to the equation (III), and a distribution of the volume values V_{HCIP} is then estimated, making it possible to quantify the uncertainty as to the static volume of hydrocarbons of the oil deposit. Table 3 below gives the values of the probability quantiles 10, 50 and 90 for the static volume of hydrocarbons.

TABLE 3

| | | | ID (%) |
|---|---|---|---|
| Q10 (Mm³) | Q50 (Mm³) | Q90 (Mm³) | (Q90 − Q10/Q50) |
| 15.69 | 23.87 | 33.15 | 73.14% |

### Analysis of Ergodicity

In the embodiment in which the static volume is calculated according to the equation (III′), only the uncertainties concerning the parameters X are taken into consideration.

Another embodiment also takes into consideration the non-ergodicity of the process for determining the static volume of hydrocarbons using the model constructed from the group of parameters.

The non-ergodicity of the process for determining the static volume of hydrocarbons is manifested by the variability of the reference volume obtained from the same base cases for all the parameters when the process is executed several times. It results in particular from the construction of the geo-model which involves stochastic processes.

In the method proposed here, the non-ergodicity can be treated as one of the sources of uncertainty, with its own probability law. It can give rise to a special bar in the tornado diagram.

To estimate the probability law of the static volume of hydrocarbons for this source of uncertainty, the process for determining the static volume of hydrocarbons is executed several times by taking all the sources of uncertainty associated with the parameters on their respective base cases, in the step 220. A set of values of the static volume of hydrocarbons is then obtained, from which the reference volume V_{BC} will be chosen.

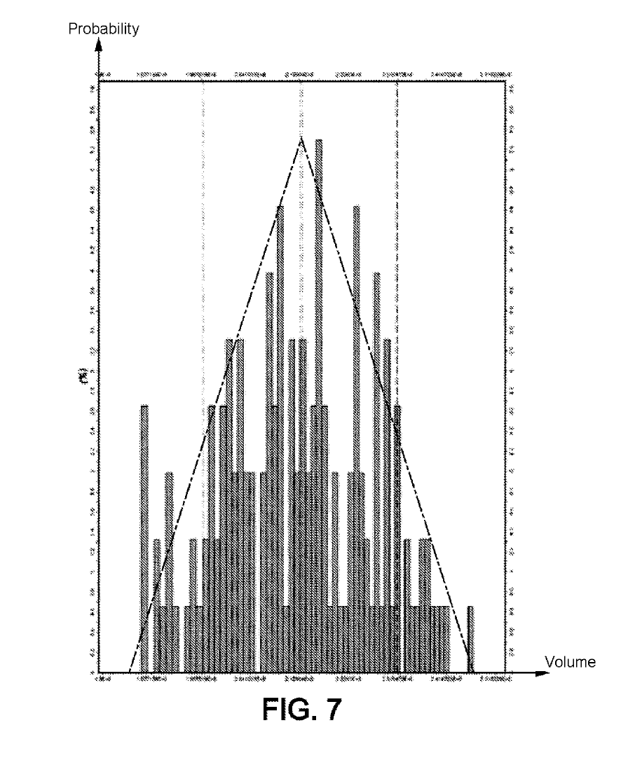

The values that are thus calculated are gathered together in a histogram, for example like the one represented in FIG. 7. It can be seen that the reference volume that can be obtained by determining it simply from the values of the base cases for the different parameters, without taking into account the non-ergodicity, can assume a variety of values. The histogram illustrates a sampling of the probability law associated with the non-ergodicity. A probability law proportional to the levels of the histogram can be taken, or the latter can be approached by an appropriate mathematical form. It is notably possible to once again take a triangular law, as illustrated by chain-dotted line in FIG. 7. The reference volume V_{BC} chosen for the series of calculations is for example taken to be equal to the median value of the distribution.

In the step 240, the Monte Carlo-type draw of the volume values for the different sources of uncertainty is performed for the sources of uncertainty linked to the parameters X (volumes V_{Xj} sampled according to the probability law associated with the j^{th} source of uncertainty of the parameter X over all the m draws) and for the non-ergodicity (volume V_{NE} sampled according to the probability law associated with the non-ergodicity over all the m draws).

In the expression (III) of the volume of hydrocarbons in place for a draw of the volume values for the sources of uncertainty, β is then taken to be proportional to the volume V_{NE} drawn for the non-ergodicity. In particular, β can be taken to be equal to V_{NE}, the equation (III) then being written:

$${V}_{HCIP} = {V}_{NE} \times {\prod }_{X} [ 1 + {\sum }_{j = 1}^{{n}_{X}} ( \frac{{V}_{Xj} - {V}_{BC}}{{V}_{BC}} ) ] \qquad ( {III}^{″} )$$

which is equivalent to (III′) if the source of uncertainty relating to the non-ergodicity is added into the expression of the product.

### Extraction of Quantiles

Once the distribution of the static volume has been assessed, according to the equation (III′) or the equation (III″) or another formula, fluid flow simulations are performed on the basis of custom models, in order to quantify the dynamic uncertainties or assess the production which will be able to take place over a given period.

The custom models used in the flow simulations are constructed for target values of the static volume. For a target value of the static volume in the distribution determined in the step 260 of FIG. 2, there are very many sets of parameters giving rise to a static volume with this value. These different sets of parameters penalize to a greater or lesser extent the parameters relative to one another. It is therefore essential to choose the levels of uncertainty for each property involved, which can be done by uniformly setting the quantiles of the different properties by taking into account uncertainties which are associated with them. This method is preferable to the multi-realization method which generates a large number of models which can be very different from one another.

The process of extracting quantiles (FIG. 1) makes it possible to construct a single model, for a target value of the static volume, by appropriately improving or degrading the parameters of the base case. Thus, an approximation is made, which is very useful for speeding up the study of the subsoil, with the a priori most acceptable hypothesis.

This process of extracting quantiles provides a response to a question with no solution: how to build ONE model corresponding to ONE given volume in a context of uncertainty in which an infinity of models are a priori possible. The construction of this single model notably makes it possible to conduct tests on the sensitivity of the economic efficiency of a product with degraded or upgraded cases.

Consider for example a target static volume of 110 (in arbitrary units) for a hydrocarbon reservoir and two models (1 and 2) of this reservoir giving rise to the values of Table 4 (in which B_{H}=1FVF) for the factors of the equation (I); it can be seen that the calculated static volume V_{HCIP} corresponds to the target volume sought even though the models can be very different.

TABLE 4

| | Model 1 | Model 2 |
|---|---|---|
| BRV | 1000 | 982 |
| NTG | 0.8 | 0.82 |
| Φ | 0.22 | 0.18 |
| S_{H} | 0.75 | 0.85 |
| B_{H} | 1.2 | 1.12 |
| V_{HCIP} | 110 | 110 |

### Extraction of Quantiles—1^{st} Approach

A first approach to the extraction of quantiles is based on uniform quantiles.

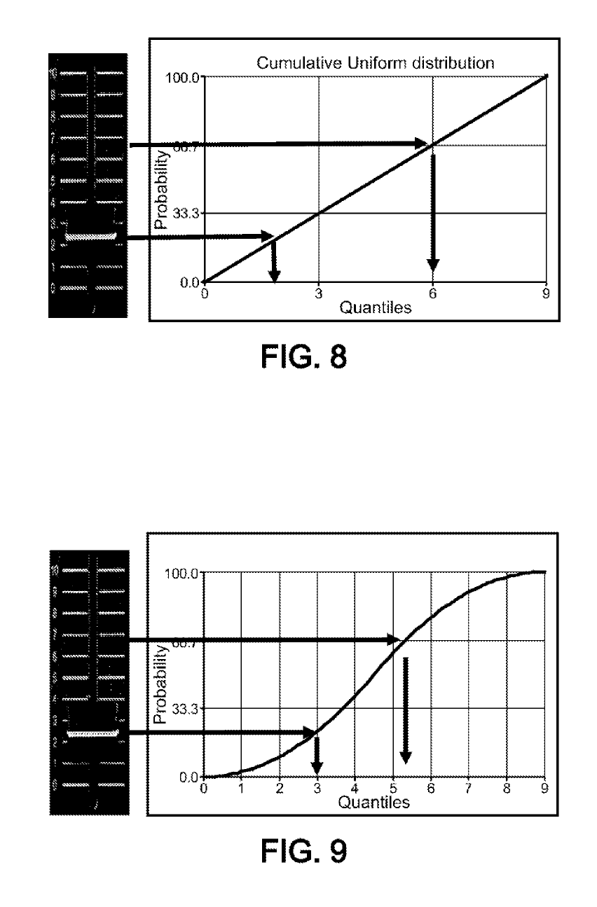

In this document, the common misuse of language is applied whereby “quantile” is used to denote the value of a parameter but also the probability of being below this value. For example, with reference to FIG. 8 which shows the distribution function associated with a uniform law of probability that a parameter takes a value between 0 and 9, the value 6 is a quantile, denoted Q66.7 because there is a 66.7% chance that the parameter is below the value 6. However, the quantile 66.7 can, incorrectly, be referred to, whereas the correct expression would be “probability quantile 66.7”. The first approach to the extraction of the quantiles is based on uniform quantile probabilities or, by misuse of language, on “uniform quantiles”.

The aim is therefore to construct a model with the same quantile (in fact the same probability) of uncertainty for the different sources of uncertainty. There is thus an assurance that the model is “uniform” in terms of uncertainties, by avoiding pathological cases with extreme parameter values which compensate one another.

The distribution functions illustrated in FIGS. 8 and 9 correspond to an example in which the probability laws estimated for two parameters varying between 0 and 9 (in arbitrary units) and representing two independent sources of uncertainty are respectively a uniform law and a triangular law. If the uncertainty is set at 66.7%, the value 6 is obtained for the first parameter (FIG. 8) and the value 5.3 is obtained for the second (FIG. 9).

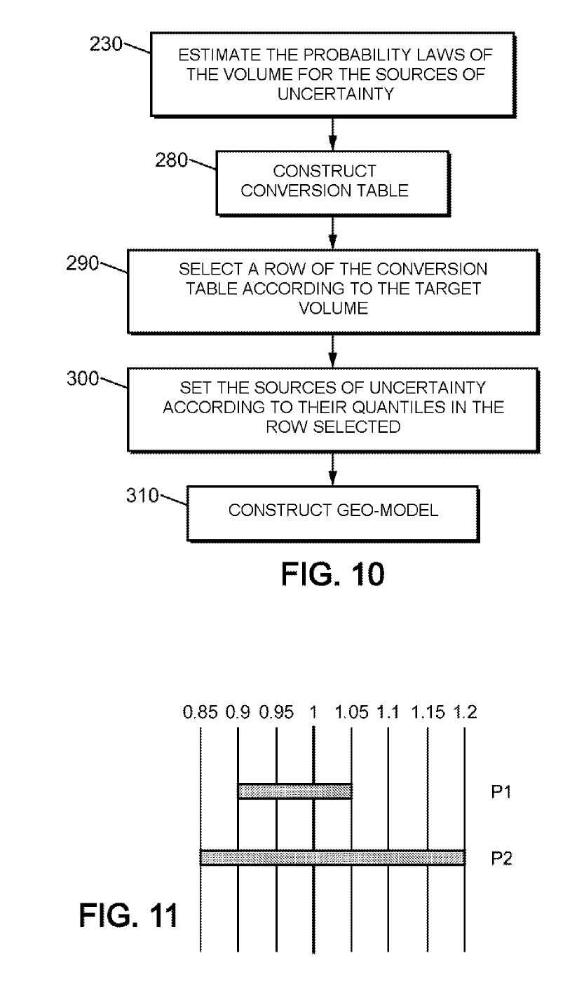

To implement the method for extracting quantiles, the first step consists in estimating the probability laws of the static volume of hydrocarbons for the different sources of uncertainty taken into account, in the manner described previously (step 230 of FIG. 2 represented again in FIG. 10).

Then, a conversion table giving respective values of the static volume as a function of values of an assumed uniform probability quantile for the different sources of uncertainty taken into account is determined (step 280 of FIG. 10). The values of the static volume can notably be expressed proportionally to the reference volume V_{BC}.

With a target value of the static volume of hydrocarbons being given, a row of the conversion table is selected in the step 290. This is the row that has the target value in the column relating to the static volume of hydrocarbons.

In the step 300, each source of uncertainty is set according to its probability quantile in the row which has been selected in the conversion table. Then, in the step 310, the single model is constructed which will be used to describe the reservoir assumed to contain the starting target volume with the duly set sources of uncertainty.

To illustrate this implementation of the method for extracting quantiles, a simplified example is considered, illustrated by the two-bar tornado diagram of FIG. 11, in which only two sources of uncertainties P1, P2 are taken into account, relating to different parameters X1 , X2 and associated with triangular probability laws given by the respective triplets (0.9; 1; 1.05) and (0.85; 1; 1.2). In other words, P1, the favorable case at Q100 gives a static volume V1_{S}=1.05×V_{BC} and the unfavorable case at Q0 gives a static volume V2_{S}=0.9×V_{BC}, whereas, for P2, the favorable case at Q100 gives a static volume V1_{S}=1.2×V_{BC} and the unfavorable case at Q0 gives a static volume V2_{S}=0.85×V_{BC}. It will be observed that P1 and P2 could have probability laws other than the triangular laws mentioned here for the purposes of the example.

The expression of the static volume given by the equation (III) or a similar equation makes it possible to determine the abovementioned conversion table which, in the example, corresponds to Table 5 below, in which the rows are sampled by quantile units Q_{P} of the sources of uncertainty. It should be noted that, if a number of sources of uncertainty affect the same parameter X, the expression of the static volume is no longer a simple product but involves sums, as expressed by the equations (III), (III′) and (III″).

TABLE 5

| Q_{P} | V_{P1}/V_{BC} | V_{P2}/V_{BC} | Volume V_{HCIP} | with β = 100 |
|---|---|---|---|---|
| 0 | 0.9 | 0.85 | β × 0.9 × 0.85 | 76.5 |
| 1 | 0.912 | 0.873 | β × 0.912 × 0.873 | 79.6 |
| . . . | . . . | . . . | . . . | . . . |
| 18 | 0.952 | 0.947 | β × 0.952 × 0.947 | 90 |
| . . . | . . . | . . . | . . . | . . . |
| 43 | 0.98 | 1 | β × 0.98 × 1 | 98 |
| . . . | . . . | . . . | . . . | . . . |
| 67 | 1 | 1.05 | β × 1 × 1.05 | 105 |
| . . . | . . . | . . . | . . . | . . . |
| 99 | 1.041 | 1.174 | β × 1.041 × 1.174 | 122.2 |
| 100 | 1.05 | 1.2 | β × 1.05 × 1.2 | 126 |

The value 1 in the column V_{Pj}/V_{BC} corresponds to the base case quantile for the source of uncertainty Pj (Q67 for P1 and Q43 for P2).

To reach a target static volume, the last column of the table is scanned in the step 290. Once the volume is found, the corresponding uniform quantile Q_{P} is read in the first column to set the sources of uncertainty in the step 300. In the above numerical example, a target static volume of 90, corresponding to a Q10 in terms of volume, corresponds to the combination of two sources of uncertainty set to their quantile Q18.

Returning to the example of the triangular law associated with a source of uncertainty for which the unfavorable case corresponds to Q0, and the favorable case corresponds to Q100 (equations (II) above), the expression of the distribution function F(V_{S}) for this source of uncertainty is:

$$F ( {V}_{S} ) = 0 for {V}_{S} \leq V {1}_{S} ; \\ F ( {V}_{S} ) = \frac{{( {V}_{S} - V {1}_{S} )}^{2}}{( {V}_{BC} - V {1}_{S} ) ( {V2}_{S} - V {1}_{S} )} for V {1}_{S} \leq {V}_{S} \leq {V}_{BC} ; \\ F ( {V}_{S} ) = 1 - \frac{{( V {2}_{S} - {V}_{S} )}^{2}}{( V {2}_{S} - {V}_{BC} ) ( V {2}_{S} - V {1}_{S} )} for {V}_{BC} \leq {V}_{S} \leq V {2}_{S} ; \\ a nd \\ F ( {V}_{S} ) = 1 for {V}_{S} \geq V {2}_{S} . \qquad ( V )$$

The probability quantile Q associated with a quantile value V_{S} is then given by Q=100×F(V_{S}). For example, the probability quantile associated with the base case is Q_{BC}=100×q_{BC}, where

$${q}_{B C} = \frac{( {V}_{B C} - V {1}_{S} )}{( V {2}_{S} - V {1}_{S} )} .$$

Conversely, it is possible to switch from a probability quantile value Q to the corresponding volume value V_{S}=F⁻¹(Q/100):

F⁻¹(q)=V1_{S}+\sqrt{q·(V_{BC}−V1_{S})·(V2_{S}−V1_{S})} for 0≦q≦q_{BC}; and

F⁻¹(q)=V2_{S}−\sqrt{(1−q)(V2_{S}−V_{BC})(V2_{S}−V1_{S})} for q_{BC}≦q≦1. (VI)

The expressions of the functions F and F⁻¹ given above in the particular case of a triangular law can easily be generalized, analytically or numerically, to a probability law of any form.

In the first approach to the extraction of the quantiles, the construction 280 of the conversion table comprises the determination of the volumes V_{S} which, according to the lo probability laws associated with the different sources of uncertainty, correspond to the sampled uniform quantiles, these volumes V_{S} being able to be expressed in their reduced form V_{S}/V_{BC}. This determination of the volumes V_{S} uses the expression of F⁻¹ as, for example, that of the equations (VI) in the case of triangular laws. The columns of the conversion table are thus filled with uniform quantiles, each row corresponding to a sampled quantile. Then, the equation (III), (III′) or (III″) is applied to determine the volume values for each row of the conversion table.

### Extraction of Quantiles—2^{nd} Approach

The preceding approach addresses the issue of the extraction of the quantiles, but without ensuring that an unfavorable (or favorable) case in terms of volume is necessarily unfavorable (or favorable) for all the sources of uncertainty taken into account. Now, this case occurs notably for the contacts which can be associated with strongly dissymmetrical probability laws.

In general, it is preferable that, when an unfavorable case in terms of volume, i.e. a volume less than that of the base case, is chosen as target, the quantile proposed for each of the sources of uncertainty is less than that of its respective base case. Similarly, it is preferable that, when a favorable case in terms of volume, i.e. a volume greater than that of the base case, is chosen as target, the quantile proposed for each of the sources of uncertainty is greater than that of its respective base case.

In the above example, the quantile in terms of volume of the base case (i.e. the quantile corresponding to V_{BC}) in the distribution of the volumes is Q52, whereas the sources of uncertainty P1, P2 have their respective base cases on the quantiles Q67 and Q43. If the target is a target static volume of quantile less than Q52 (an unfavorable case), it is suitable for P1 to have a quantile less than 67 and P2 to have a quantile less than 43. If the target is a volume of quantile greater than Q52 (a favorable case), it is suitable for P1 to have a quantile greater than 67 and P2 to have a quantile greater than 43.

For that, the conversion table is rearranged as follows:

TABLE 6

| | | Source of | | Source of | | |
|---|---|---|---|---|---|---|
| | | uncertainty P1 | | uncertainty P2 | | |
| | | Q_{P1} | V_{P1}/V_{BC} | Q_{P2} | V_{P2}/V_{BC} | Volume V_{HCIP} |
| | | 0 | 0.9 | 0 | 0.85 | β × 0.765 |
| m | | 0.7 | 0.91 | 0.4 | 0.865 | β × 0.78715 |
| samples | {open oversize brace} | 2.7 | 0.92 | 1.7 | 0.88 | β × 0.8096 |
| | | . . . | . . . | . . . | . . . | . . . |
| | | 54 | 0.99 | 30 | 0.975 | β × 0.96525 |
| | | 67 | 1 | 43 | 1 | β [V_{BC}] |
| | | 73 | 1.005 | 54 | 1.02 | β × 1.0251 |
| n | | 79 | 1.01 | 63 | 1.04 | β × 1.0504 |
| samples | {open oversize brace} | . . . | . . . | . . . | . . . | . . . |
| | | 99.7 | 1.045 | 99.4 | 1.18 | β × 1.2331 |
| | | 100 | 1.05 | 100 | 1.2 | β × 1.05 × 1.2 |

The rearrangement consists in aligning the base cases of the different sources of uncertainty and in sampling the probability laws above and below the base case in the same way for all the sources of uncertainty, i.e. with the same number of samples above or below the base case. The number of samples per source of uncertainty from the unfavorable case to the base case is denoted m in Table 6 above, whereas the number of samples per source of uncertainty from the base case to the favorable case is denoted n. The numbers m and n are typically equal (in Table 6, m=n=10), but they can equally be different.

The method for switching from the target volume to the quantiles is similar to that of the first approach, the quantiles however being different according to the sources of uncertainty.

In the above numerical example, a target static volume of 90 (a Q10 in volume) corresponds to the combination of a Q15 for the source of uncertainty P1 and of a Q23 for the source of uncertainty P2 (instead of a Q18 for each in the 1^{st} approach above).

In Table 6, the sampling is at regular intervals in terms of V_{Pj}/V_{BC} on either side of the base case, with the same number of intervals for each source Pj. It may be appropriate to provide an irregular sampling, notably with narrower intervals in proximity to the base case where the sensitivity in quantiles is greater.

In the second approach to the extraction of the quantiles, the construction 280 of the conversion table comprises:
aligning the base cases of the different sources of uncertainty on one and the same row (V_{Pj}/V_{BC}=1 in Table 6), in which the reference volume V_{BC} is to be found in the column relating to the volume V_{HCIP};
choosing m sampling points in the interval [V1_{S}/V_{BC}, 1[ for each source of uncertainty: V1_{S}, V1_{S}+Δ₁×(V_{BC}−V1_{S}), V1_{S}+Δ₂×(V_{BC}−V1_{S}), . . . , V1_{S}+Δₘ₋₁×(V_{BC}−V1_{S}), where Δ₀=0, Δ₁, Δ₂, . . . , Δₘ₋₁ are numbers increasing between 0 and 1 identically chosen for all the sources of uncertainty (Δᵢ=i/m in the case of a sampling at regular intervals), the sampling points having different volume values because V1_{S} depends on the source of uncertainty concerned. In the conversion table, all the sampling points obtained with the same coefficient Δᵢ are placed on the same row (the (i+1)^{th} row);
choosing n sampling points in the interval ]1, V2_{S}/V_{BC}] for each source of uncertainty: V_{BC}+Δ′₁×(V2_{S}−V_{BC}), V_{BC}+Δ′₂×(V2_{S}−V_{BC}), . . . , V_{BC}+Δ′ₙ₋₁×(V2_{S}−V_{BC}), V2_{S} where Δ′₁, Δ′₂, . . . , Δ′ₙ₋₁, Δ′ₙ=1 are numbers increasing between 0 and 1 identically chosen for all the sources of uncertainty (Δ′ₖ=k/n in the case of a sampling at regular intervals), the sampling points having different volume values because V2_{S} depends on the source of uncertainty concerned. In the conversion table, all the sampling points obtained with the same coefficient Δ′ₖ are placed on the same row (the (m+k+1)^{th} row);
for each of the m+n sampling points chosen and each of the sources of uncertainty Pj, calculating an associated quantile Q_{Pj} relative to the probability law which has been estimated for the source of uncertainty. This calculation uses the expression of the distribution function F as, for example, that of the equations (V) above in the case of triangular laws;
calculating a respective volume value V_{HCIP} for each row of the conversion table, using the equation (III), (III′) or (III″) according to the relative volumes V_{Pj}/V_{BC} corresponding to the different sources of uncertainty, and the storage of this value V_{HCIP} in the last column of the table.

Once the conversion table is constructed in the step 280 of FIG. 10 in the second approach to the extraction of the quantiles, the step 290 consists here also in scanning the last column of the table to reach a target static volume. Once this target volume has been found, the respective quantiles Q_{Pj} which correspond to it for the different sources of uncertainty are read in the conversion table to set the sources of uncertainty in the step 300. The geo-model can then be constructed in the step 310.

Alternatively, the sampling of the rows of the conversion table is conducted in the quantiles domain rather than the volumes domain. In other words, the choice of the m sampling points takes place in the interval [0, q_{BC}[ for each source of uncertainty (0, Δ₁×q_{BC}, Δ₂×q_{BC}, . . . , Δₘ₋₁×q_{BC}), and that of the n sampling points takes place in the interval ]q_{BC}, 1] (q_{BC}+Δ′₁×(1−q_{BC}), q_{BC}+Δ′₂×(1−q_{BC}), . . . , q_{BC}+Δ′ₙ₋₁×(1−q_{BC}), 1). For each of the m+n sampling points chosen and each of the sources of uncertainty Pj, it is then necessary to calculate an associated volume V_{Pj} relative to the probability law which has been estimated for the source of uncertainty. This calculation uses the expression of the inverse function F⁻¹ as, for example, that of the equations (VI) above in the case of triangular laws.

The above method is typically implemented using one or more computers. Each computer can comprise a computation unit of processor type, a memory for storing data, a permanent storage system such as one or more hard disks, communication ports for managing communications with external devices, notably for recovery of the available data concerning the surveyed area of the subsoil (seismic imaging, measurements conducted in the wells, etc.), and user interfaces such as, for example, a screen, a keyboard, a mouse, etc.

Typically, the calculations and the steps of the method described above are executed by the processor or processors by using software modules which can be stored, in the form of program instructions or code that can be read by the computer and that can be run by the processor, on a computer-readable storage medium such as a read-only memory (ROM), a random-access memory (RAM), CD-ROMs, magnetic tapes, diskettes and optical data storage devices.

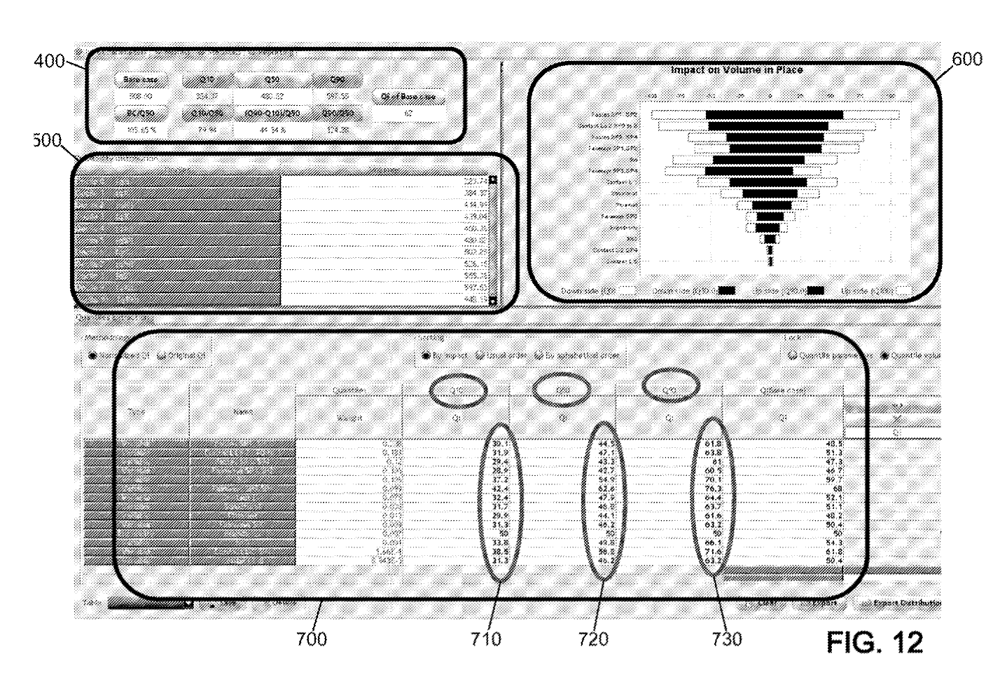

By way of example, the user may be presented with an interface of the type of that shown in FIG. 12. In this example, the graphical interface presented to the user comprises:
a box 400 where the elements relating to the base case are summarized: reference volume (V_{BC}=508 in this example); values of the quantiles Q10, Q50 and Q90 of the distribution of the static volume V_{HCIP} estimated in the reservoir, quantile of the base case, etc.;
a box 500 giving the quantiles in 10s of the distribution of the static volume V_{HCIP};
a box 600 containing the tornado diagram illustrating the impact of the different sources of uncertainty on the static volume V_{HCIP};
a box 700 concerning the extraction of the quantiles. This box 700 gives a set of quantiles of the sources of uncertainty extracted for a target value of the static volume, identified by its quantile in the distribution of the volume V_{HCIP}. In the example represented, there is a set 710 of quantiles of the sources of uncertainty for the quantile Q10 of the static volume, a set 720 of quantiles of the sources of uncertainty for the quantile Q50 of the static volume, and a set 730 of quantiles of the sources of uncertainty for the quantile Q90 of the static volume.

The embodiments described above are illustrations of the present invention. Various modifications can be made thereto without departing from the scope of the invention which emerges from the attached claims.

1. A method for assessing the static volume of hydrocarbons in a deposit, wherein the static volume of hydrocarbons is determinable using a model constructed from a group of parameters, wherein a number of mutually independent sources of uncertainty are taken into account, at least some of the sources of uncertainty being associated with respective parameters of the group, the method comprising:
selecting a base case for each source of uncertainty taken into account;
determining a reference volume as a static volume of hydrocarbons obtained with the sources of uncertainty in accordance with the respective base cases;
for each source of uncertainty taken into account, estimating a probability law for the static Volume of hydrocarbons when said source of uncertainty varies while the other sources of uncertainty conform to their respective base cases;
performing a set of draws of volume values, each draw comprising a respective volume value for each source of uncertainty taken into account, such that the volume values for a given source of uncertainty obey, over all of the draws, the probability law of the static volume of hydrocarbons estimated for said given source of uncertainty;
for each draw, calculating a realization of a volume value V_{HCIP} proportionally to:
$${\prod }_{X} [ 1 + {\sum }_{j = 1}^{{n}_{X}} ( \frac{{V}_{Xj} - {V}_{BC}}{{V}_{BC}} ) ] . \qquad$$
where V_{BC} is the reference volume, X is a parameter of said group, n_{X} is the number of sources of uncertainty associated with the parameter X, and V_{Xj} is the volume value draw for the j^{th} uncertainty of the parameter X in said draw; and
estimating a distribution of the calculated volume values V_{HCIP}.

2. The method as claimed in claim 1, wherein the estimation of the probability law for the static volume of hydrocarbons for a source of uncertainty associated with a parameter of the group comprises:
selecting an unfavorable case and a favorable case for said source of uncertainty;
determining a first static volume of hydrocarbons when said source of uncertainty conforms to the unfavorable case thereof and the other sources of uncertainty conform to the respective base cases thereof;
determining a second static volume of hydrocarbons when said source of uncertainty conforms to the favorable case and the other sources of uncertainty conform to the respective base cases thereof; and
defining said probability law for the static volume of hydrocarbons as a function of the reference volume and of said first and second volumes.

3. The method as claimed in claim 2, wherein the probability law of the volume of hydrocarbons defined for a source of uncertainty associated with a parameter of the group is chosen from a triangular law, a uniform law, a normal law, a log-normal law, a beta law.

4. The method as claimed in claim 1, wherein, for a given draw of the volume values, the volume value is calculated as being equal to:
$${V}_{BC} \times {\prod }_{X} [ 1 + {\sum }_{j = 1}^{{n}_{X}} ( \frac{{V}_{Xj} - {V}_{BC}}{{V}_{BC}} ) ] . \qquad$$

5. The method as claimed in claim 1, wherein the sources of uncertainty comprise non-ergodicity of a process for determining the static volume of hydrocarbons using the model constructed from the group of parameters.

6. The method as claimed in claim 5, wherein the estimation of the probability law of the static volume of hydrocarbons for the non-ergodicity of the determination process comprises:
executing several times said process with all the sources of uncertainty associated with the parameters of said group in accordance with their respective base cases, to determine a set of values of the static volume of hydrocarbons; and
assessing a distribution of the volume values of the set.

7. The method as claimed in claim 6, wherein the probability law of the volume of hydrocarbons for the non-ergodicity of the determination process is a law estimated by an approximation of said distribution of the volume values.

8. The method as claimed in claim 5, wherein, for a given draw of the volume values, the volume value V_{HCIP} is calculated as being proportional to:
$${V}_{NE} \times {\prod }_{X} [ 1 + {\sum }_{j = 1}^{{n}_{X}} ( \frac{{V}_{Xj} - {V}_{BC}}{{V}_{BC}} ) ] .$$
where V_{NE} is the volume value drawn for the non-ergodicity of the determination process in said draw.

9. The method as claimed in claim 8, wherein, for a given draw of the volume values, the volume value V_{HCIP} is calculated as being equal to:
$${V}_{NE} \times {\prod }_{X} [ 1 + {\sum }_{j = 1}^{{n}_{X}} ( \frac{{V}_{Xj} - {V}_{BC}}{{V}_{BC}} ) ] .$$

10. The method as claimed in claim 1, further comprising:
representing an impact of the different sources of uncertainty on the volume of hydrocarbons in the form of a tornado diagram comprising a bar representative of the probability law of the static volume of hydrocarbons for each source of uncertainty taken into account, positioned relative to a reference point corresponding to the reference volume.

11. The method as claimed in claim 10 wherein the bar of the tornado diagram relative to a source of uncertainty has a first extreme point corresponding to a first static volume of hydrocarbons and a second extreme point corresponding to a second static volume of hydrocarbons, the first static volume of hydrocarbons being determined with said source of uncertainty conforming to a selected unfavorable case and the other sources of uncertainty conforming to the respective base case thereof, and the second static volume of hydrocarbons being determined with said source of uncertainty conforming to a selected favorable case and the other sources of uncertainty conforming to their respective base cases thereof.

12. The method as claimed in claim 10, wherein the impact is expressed in an absolute manner in the tornado diagram, the value of the reference point being set at zero, the value of the first extreme point being equal to a deviation between the reference volume and the first volume, and the value of the second extreme point being equal to the deviation between the reference volume and the second volume.

13. The method as claimed in claim 1, wherein said group of parameters comprises at least one bulk apparent volume BRV, the ratio between a net apparent volume and the bulk apparent volume NTG, the porosity of the reservoir rock Φ, the hydrocarbon saturation of the reservoir rock S_{H}.

14. The method as claimed in claim 13, wherein said group of parameters further comprises a formation volume factor FVF.

15. The method as claimed in claim 1, wherein the sources of uncertainty are linked to the parameters of said group and to properties of geo-model modeling the hydrocarbon deposit, said parameters and properties being chosen from the following elements: the structure of the deposit, the contact or contacts, the geological bodies within this structure, the facies within the geological bodies, the petro-physical properties of the different types of rocks of the geological bodies, such as the porosity or the saturation, the bulk apparent volume BRV, the ratio between the net apparent volume and the bulk apparent volume NTG, the porosity of the reservoir rock Φ, the hydrocarbon saturation of the reservoir rock S_{H}, the formation volume factor FVF.

16. A device for assessing a static volume of hydrocarbons in a deposit, the device comprising at least one computation unit, wherein the static volume of hydrocarbons is determinable using a model constructed from a group of parameters, wherein the at least one computation unit is configured to take into account a number of mutually independent sources of uncertainty, at least some of the sources of uncertainty being associated with respective parameters of the group, wherein the at least one computation unit is further configured to execute the steps of:
selecting a base case for each source of uncertainty taken into account;
determining a reference volume as a static volume of hydrocarbons obtained with the sources of uncertainty in accordance with their respective base cases;
for each source of uncertainty taken into account, estimating a probability law for the static volume of hydrocarbons when said source of uncertainty varies while the other sources of uncertainty conform to their respective base cases;
performing a set of draws of volume values, each draw comprising a respective volume value for each source of uncertainty taken into account, such that the volume values for a given source of uncertainty obey, over all of the draws, the probability law of the static volume of hydrocarbons estimated for said given source of uncertainty;
for each draw, calculating a realization of a volume value V_{HCIP} proportional to:
$${\prod }_{X} [ 1 + {\sum }_{j = 1}^{{n}_{X}} ( \frac{{V}_{Xj} - {V}_{BC}}{{V}_{BC}} ) ] .$$
where V_{BC} is the reference volume, X is a parameter of said group, n_{X} is the number of sources of uncertainty associated with the parameter X, and V_{Xj} is the volume value drawn for the j^{th} uncertainty of the parameter X in said draw; and
estimating a distribution of the calculated volume values V_{HCIP}.

17. (canceled)

18. A computer-readable memory medium having a computer program code stored thereon, wherein the computer program code comprises instructions for assessing a static volume of hydrocarbons in a deposit when run by a computer, wherein the static volume of hydrocarbons is determinable using a model constructed from a group of parameters, wherein the instructions are arranged to take into account a number of mutually independent sources of uncertainty, at least some of the sources of uncertainty being associated with respective parameters of the group, wherein said instructions comprise instructions to execute the following steps when run by the computer;
selecting a base case for each source of uncertainty taken into account;
determining a reference volume as a static volume of hydrocarbons obtained with the sources of uncertainty in accordance with their respective base cases;
for each source of uncertainty taken into account, estimating a probability law for the static volume of hydrocarbons when said source of uncertainty varies while the other sources of uncertainty conform to their respective base cases;
performing a set of draws of volume values, each draw comprising a respective volume value for each source of uncertainty taken into account, such that the volume values for a given source of uncertainty obey, over all of the draws, the probability law of the static volume of hydrocarbons estimated for said given source of uncertainty; for each draw, calculating a realization of a volume value V_{HCIP} proportionally to:
$${\prod }_{X} [ 1 + {\sum }_{j = 1}^{{n}_{X}} ( \frac{{V}_{Xj} - {V}_{BC}}{{V}_{BC}} ) ] .$$
where V_{BC} is the reference volume, X is a parameter of said group, n_{X} is the number of sources of uncertainty associated with the parameter X, and V_{Xj} is the volume value drawn for the j^{th} uncertainty of the parameter X in said draw; and
estimating a distribution of the calculated volume values V_{HCIP}.
